(19) United States
(12) Patent Application Publication
(10) Pub. No.: US 2009/0102770 A1
(43) Pub. Date: Apr. 23, 2009

(54) DISPLAY DEVICE

(75) Inventors: Satoshi IWATA, Kawasaki (JP); Kohei TERAZONO, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/250,810

(22) Filed: Oct. 14, 2008

(30) Foreign Application Priority Data
Oct. 19, 2007 (JP) 2007-271964

(51) Int. Cl. G09G 3/36

(52) U.S. Cl. 345/89

(57) ABSTRACT

A display device includes a reflection type display unit reflecting light of a predetermined wavelength at a front surface side of the display device to display a first image at the front surface side; a light emission type display unit disposed at a back side of the reflection type display unit and displaying a second image different from the first image at the front surface side through the reflection type display unit; and an optical deflection element causing a viewing angle of the light emission type display unit to be smaller than a viewing angle of the reflection type display unit.

### CROSS-REFERENCE TO RELATED APPLICATIONS

This application is based upon and claims the benefit of priority from the prior Japanese Patent Application No. 2007-271964, filed on Oct. 19, 2007, the entire content of which is incorporated herein by reference.

### BACKGROUND

1. Field

The embodiments discussed herein are directed to a display device for use in a display unit of electronic equipment.

2. Description of the Related Art

A display device is mounted in portable equipment such as cellular phone equipment or the like in some cases. The display screen of the display device is viewed by not only a user, but also persons surrounding the user. Therefore, from the viewpoint of personal information protection, it has been required to restrict the angle of a viewable field of the screen.

For example, a pamphlet of International Publication No. 2004/015330A1 discuses a liquid crystal display device (LCD; Liquid Crystal Display) in which the viewing angle of the screen is structurally limited.

However, for the above requirement, it is necessary to further limit the viewing angle, and thus an optical deflection element is provided in the screen so that an image displayed on the screen can be viewed from only a limited viewing angle such as a front side or the like.

FIG. 1 is a schematic cross-sectional view showing a display device with an optical deflection element associated with a related art. FIG. 2 is a front view of the optical deflection element having a striped light shielding portion.

As shown in FIG. 1, the display device 800 related to the related art has a light source 705, a transmission type liquid crystal display panel 703 for transmitting light emitted from the light source 705 and an optical deflection element 709. In the optical deflection element 709, light shielding portions m for shielding incident light and light transmitting portions n for transmitting incident light therethrough are alternately arranged in a strip pattern as shown in FIG. 2.

As shown in FIG. 1, in the case of use of an optical deflection element having striped light shield portions m, the viewing angle is restricted in the arrangement direction in which plural light shielding portions m and plural light transmitting portions n are alternately arranged along the transmission type liquid crystal display panel 703 (that is, in the right-and-left direction). On the other hand, in the case of use of an optical deflection element having plural striped light shielding portions m which are arranged in a grid pattern so as to be orthogonal to one another along the transmission type liquid crystal display panel 703, the viewing angle in all the directions containing not only the right-and-left direction, but also the up-and-down direction along which each light shield shielding portion m extends can be restricted.

However, in the display device using the striped light shielding portions described above, even when an image to which necessity of information protection is low is viewed, a user must match his/her visual line with the viewing angle and this is inconvenient to the user. It is considered that the display device is provided with a function of changing the viewing angle, however, it is difficult to provide such a complicated mechanism for implementing the function as described above.

### SUMMARY

According to an aspect of an embodiment, a display device includes: a reflection type display unit reflecting light of a predetermined wavelength at a front surface side to display a first image at the front surface side; a light emission type display unit disposed at a back side of the reflection type display unit and displaying a second image different from the first image at the front surface side through the reflection type display unit; and an optical deflection element making a viewing angle of the light emission type display unit smaller than a viewing angle of the reflection type display unit.

### BRIEF DESCRIPTION OF DRAWINGS

FIG. 1 is a schematic diagram showing the cross section of a display device with an optical deflection element of a related art.

FIG. 2 is a front view showing an optical deflection element of a related art having striped light shielding portions.

FIG. 3 is a cross-sectional view showing a main part of a display device according to a first embodiment.

FIG. 4A is a schematic diagram showing a state that a viewer watches a display device of a related art.

FIG. 4B is a schematic diagram showing a state that a viewer watches a display device according to a first embodiment.

FIG. 5 is a cross-sectional view showing a main part of a display device according to a second embodiment.

FIG. 6 is a cross-sectional view showing a main part of a display device according to a third embodiment.

FIG. 7 is a schematic diagram showing an aspect of light reflection from each reflection type display panel.

FIG. 8 is a cross-sectional view showing a main part of a display device according to a fourth embodiment.

FIG. 9 is a flowchart showing a brightness adjusting method of a light source on the basis of illuminance detected by an illuminance sensor unit.

FIG. 10 is a cross-sectional view showing a main part of a display device according to a fifth embodiment.

FIG. 11 is a cross-sectional view showing a main part of a display device according to a sixth embodiment.

FIG. 12 is a cross-sectional view showing a lenticular lens unit in a display device according to a seventh embodiment.

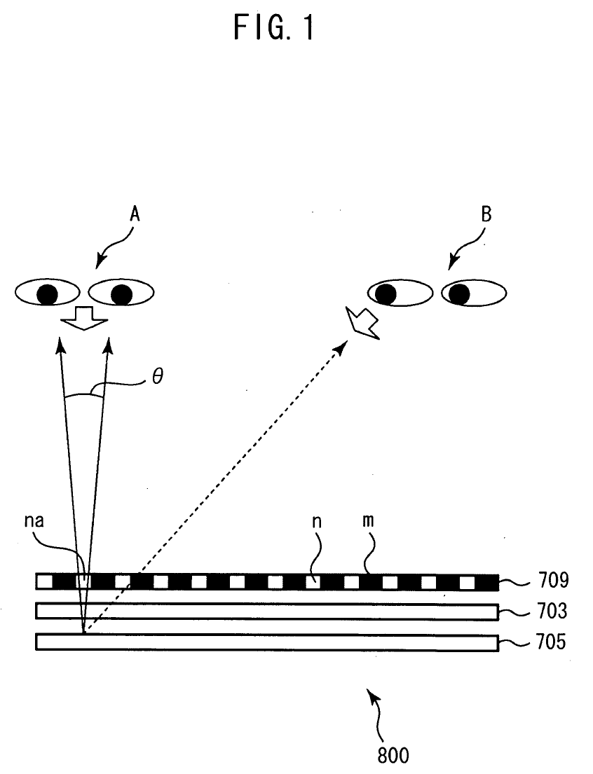

### DESCRIPTION OF EMBODIMENTS

### First Embodiment

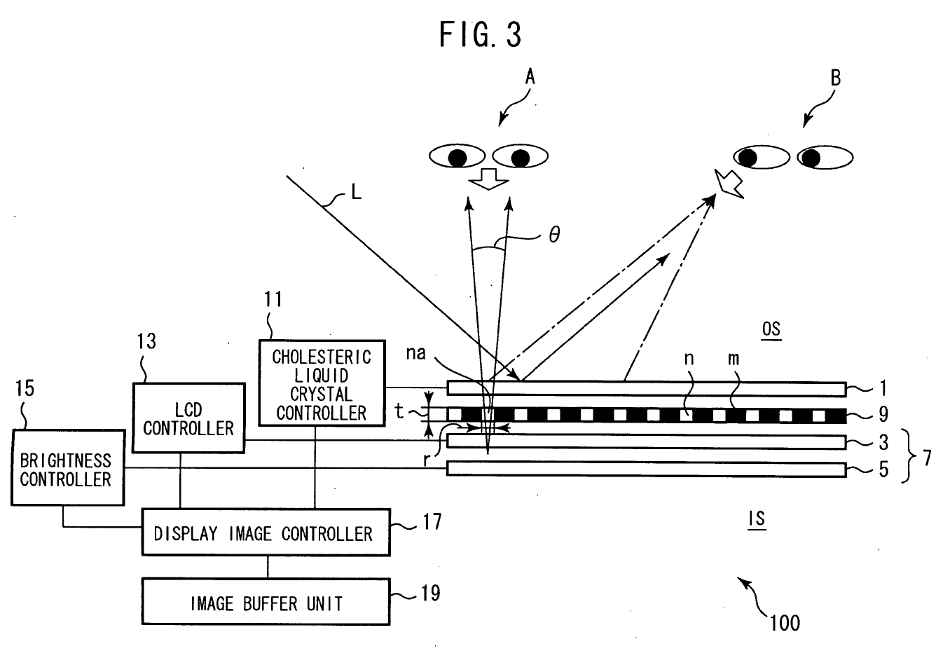

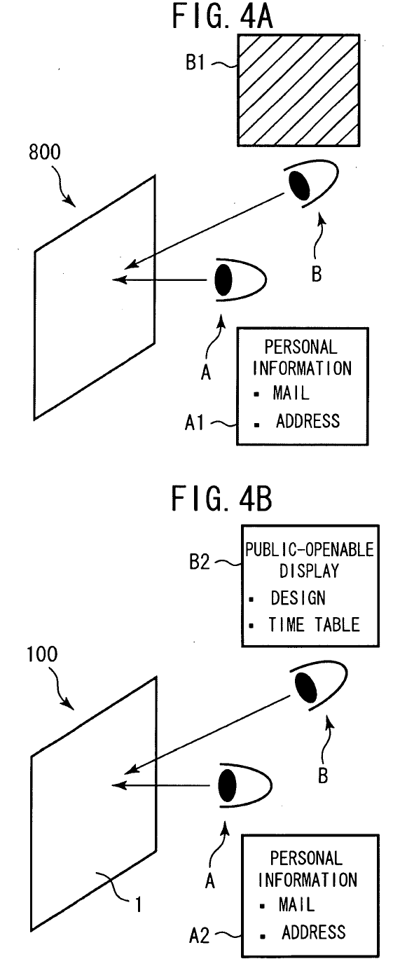

A display device according to a first embodiment will be described with reference to FIGS. 3, 4A and 4B. FIG. 3 is a cross-sectional view showing a main part of a display device 100 according to first embodiment.

The display device 100 maybe mounted in portable equipment such as cellular phone equipment or the like. The display device 100 can be viewed through a transparent panel or the like from the outside. The display device 100 includes a reflection type display unit 1, a light emission type display unit 7, an optical deflection element 9, a cholesteric liquid crystal controller 11, an LCD controller 13, a brightness controller 15, a display image controller 17 and an image buffer unit 19.

The reflection type display unit 1, the optical deflection element 9 and the light emission type display unit 7 maybe successively stacked and arranged in this order from the front surface side OS.

The reflection type display unit 1 has cholesteric liquid crystal forming a cholesteric phase, and it is disposed at the outermost position of the display device 100. In the reflection type display unit 1, light having a predetermined wavelength which is contained in irradiated light L and is clockwise or counterclockwise circularly polarized is reflected to the front surface side OS by the cholesteric liquid, thereby displaying an image (first image). For example, in the case of cholesteric liquid which reflects counterclockwise circularly polarized light having the wavelength corresponding to green, it selectively reflects the counterclockwise circularly polarized light of green out of the irradiated light L, and transmits the other light containing clockwise circularly polarized light of green therethrough. The reflection type display unit 1 of this embodiment is constructed to reflect the counterclockwise circularly polarized light having the wavelength corresponding to green.

The cholesteric liquid crystal has the structure that nematic liquid crystals are arranged spirally, and circularly polarizes the polarization state of transmitted light and reflected light. The cholesteric liquid crystal for controlling circular polarization does not deteriorate the polarization state in accordance with the light incident angle unlike TN (Twisted Nematic) liquid crystal and STN (Super Twisted Nematic) liquid crystal which control linear polarization. Therefore, a display panel using cholesteric liquid crystal can implement a broader viewing angle than a display panels using TN liquid crystal or STN liquid crystal.

The reflection type display unit 1 has scanning electrodes (not shown) and data electrodes (not shown) which compartment the display screen in a grid pattern to form pixels. These scanning electrode and data electrode are used to apply a predetermined voltage to the cholesteric liquid crystal. The display characteristic of the cholesteric liquid crystal varies on the basis of the voltage applied thereto. Light irradiated to the reflection type display unit 1 except for light having a predetermined wavelength is transmitted through the reflection type display unit 1.

The light emission type display unit 7 is a display unit for displaying an image (second image) by light emission, and it is disposed at the back side IS of the optical deflection element 9, that is, at the back side IS of the reflection type display unit 1. The light emission type display unit 7 has a transmission type liquid crystal display panel 3 and a light source 5.

The transmission type liquid crystal display panel 3 may have a transparent electrode, STN liquid crystal, a polarization filter and a color filter (all are not shown) for pixels formed on the display screen. The color filter includes three colors of red, green and blue. The transmission type liquid crystal display panel 3 performs gradation display of each pixel by applying a voltage to STN liquid crystal.

The light source 5 is controlled by the brightness controller 15 to emit light, and makes the light incident to the transmission type liquid crystal display panel 3. The light source 5 emits light having amplitude components in various directions.

Only linearly polarized light in a predetermined direction out of light emitted from the light source 5 is passed through the polarization filter and transmitted through the transmission type liquid crystal display panel 3. The light emitted from the light source 5 is adjusted in transmission amount in accordance with the gradation of each pixel when transmitted through the transmission type liquid crystal display panel 3, and it is transmitted through the reflection type display unit 1 after transmitted through the optical deflection element 9. For example, at this time, the reflection type display unit 1 reflects only counterclockwise circularly polarized light having the wavelength corresponding to green, and transmits therethrough clockwise circularly polarized light of green and other color light. Therefore, an image displayed by the light emission type display unit 7, containing the light of green other than the counterclockwise circularly polarized light, is transmitted through the reflection type display unit 1, and viewable from the front side OS.

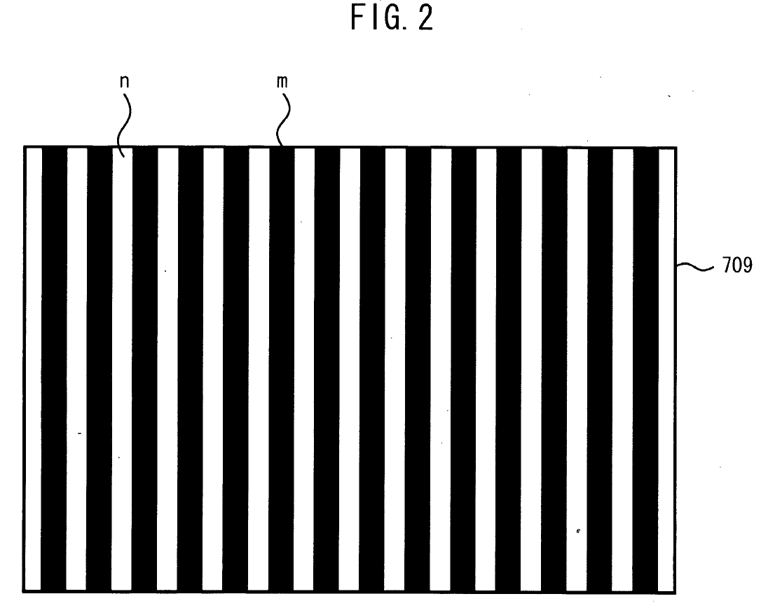

The optical deflection element 9 has substantially the same construction as shown in FIG. 2, and the viewing angle of the light emission type display unit 7 is set to be smaller than the viewing angle of the reflection type display unit 1. In the optical deflection element 9, plural light shielding portions m which are linearly formed of material having light non-transmissible material are arranged in a stripe pattern substantially at the same interval as the interval of the respective pixels of the light emission type display unit 7. Plural light transmission portions n which are linearly formed of material having light transmissible material are arranged in a strip pattern substantially at the same interval as the interval of the respective pixels of the light emission type display unit 7 as in the case of the light shielding portions m so that each light transmission portion n is located between the light shielding portions m. For example, when the light emission type display unit 7 is QVGA (Quarter VGA: resolution of 320×240 pixels) of 2.2 inch (inches) to 2.4 inch (inches), the arrangement pitches of the respective pixels and the light shielding portions m of the light emission type display unit 7 are set to 139.7 μm to 152.4 μm. When the light emission type display unit 7 is W-VGA (Wide Quarter VGA: resolution of 400×240 pixels) of 2.2 inch to 2.4 inch, the arrangement pitches of the respective pixels and the light shielding portions m of the light emission type display unit 7 are set to 119.9 μm to 130.8 μm. When the light emission type display unit 7 is VGA (Video Graphics Array: resolution of 640×480 pixels) of 2.4 inch to 2.6 inch, the arrangement pitches of the respective pixels and the light shielding portions m of the light emission type display unit 7 are set to 76.2 μm to 82.5 μm. When the light emission type display unit 7 is W-VGA (Wide VGA: resolution of 800×480 pixels) of 3.2 inch to 4.0 inch, the arrangement pitches of the respective pixels and the light shielding portions m of the light emission type display unit 7 are set to 87.1 μm to 108.9 μm.

Light which is emitted from the light emission type display unit 7 and transmitted through the reflection type display unit 1 is partially shielded by the light shielding portions m, so that light spread is restricted. With respect to the optical deflection element 9, a spreading angle area of light which is transmitted through each light transmitting portion n is determined by the height ratio between the light shielding portion m and the light transmitting portion n. Here, the angle area θ of the viewing angle in each transmitting portion n is represented by the following equation when the thickness of the light shielding portion m and the width of the transmitting portion n of the optical deflection element 9 are represented by t and r:

θ=2 tan⁻¹(t/r)

The angle range of the superposed angle areas θ of the respective transmitting portions n corresponds to the range in which a viewer can watch an image displayed on the light emission type display unit 7, that is, the viewing angle.

The display device 100 has an optical deflection element 9. Therefore, the viewing angle of the light emission type display unit 7 at the front side OS is limited to the angle area θ. Accordingly, an observer A observing within the angle area θ can watch the image displayed on the light emission type display unit 7, however, an observer B observing from the outside of the angle area θ cannot watch the image displayed on the light emission type display unit 7.

In general, it is desirable from the viewpoint of the display quality of the reflection type display unit 1 that the back surface of the display panel using the cholesteric liquid crystal is provided with light absorber or colored with black to shield incident light from the backside. The display device 100 according to this embodiment is provided with the optical deflection element 9 which transmits therethrough light incident within the angle area θ, but shields light incident from the other angle area, that is, the outside of the angle area θ. In this embodiment, the optical deflection element 9 is disposed at the back side IS of the reflection type display unit 1, whereby the light incident from the outside of the angle area θ is shielded. Therefore, the arrangement of the optical deflection element 9 at the back side IS of the reflection type display unit 1 is effective to enhance the display quality of the reflection type display unit 1 because the optical deflection element 9 acts as light absorber when the observer B watches a display image of the reflection type display unit 1 from the outside of the angle area θ.

The image buffer unit 19 is a memory. For example, it temporarily stores image data input from the system side of the portable equipment in which the display device 100 is mounted, and outputs the stored image data to the display image controller 17 under the control of the display image controller 17.

The display image controller 17 has a processor (not shown), etc., and controls the overall display device 100. The display image controller 17 switches the scan speed and driving voltage of the reflection type display unit 1 and the light emission type display unit 7 through the cholesteric liquid crystal controller 11 and the LCD controller 13 to display an image.

The display image controller 17 generates driving data on the basis of image data of an image which is obtained from the image buffer unit 19 and is to be displayed on each of the reflection type display unit 1 and the light emission type display unit 7. The display image controller 17 outputs the generated driving data and a synchronous signal to the cholesteric liquid crystal controller 11 and the LCD controller 13. At this time, the display image controller 17 outputs the image data of different images to the cholesteric liquid controller 11 and the LCD controller 13 respectively. Accordingly, the reflection type display unit 1 and the light emission type display unit 7 can display different images.

The brightness controller 15 controls the light amount of the light source 5 of the light emission type display unit 7 on the basis of an instruction of the display image controller 17. Accordingly, the light amount of light transmitted through the transmission type liquid crystal display panel 3 is adjusted, and the light emission type display unit 7 can adjust the intensity of the brightness of the image to be displayed. The display device 100 is designed to change the ratio in brightness between the reflection type display unit 1 and the light emission type display unit 7 by adjusting the brightness of the light emission type display unit 7 under the control of the brightness controller 15 when an image is displayed.

The cholesteric liquid crystal controller 11 outputs a liquid crystal gradation signal corresponding to an image displayed on the reflection type display unit 1 and a synchronous signal for displaying the image to the reflection type display unit 1. The cholesteric liquid crystal controller 11 generates the liquid crystal gradation signal and the synchronous signal on the basis of the driving data output from the display image controller 17. Accordingly, the cholesteric liquid crystal controller 11 outputs the liquid crystal gradation signal and the synchronous signal to adjust the voltage to be applied to each pixel of the reflection type display unit 1, thereby performing gradation display of each pixel.

The LCD controller 13 outputs a liquid crystal gradation signal corresponding to an image displayed on the light emission type display unit 7 and a synchronous signal for displaying the image to the light emission type display unit 7. The LCD controller 13 generates the liquid crystal gradation signal and the synchronous signal on the basis of the driving data output from the display image controller 17. Accordingly, the LCD controller 13 outputs the liquid crystal gradation signal and the synchronous signal to adjust the voltage applied to each pixel of the light emission type display unit 7, thereby performing gradation display of each pixel.

Next, a method of displaying an image by the display device 100 will be described.

As shown in FIG. 3, the display device 100 displays the image of the light emission display unit 7 for the observer A who observes the display device 100 within the spreading angle area θ of light transmitted through the transmitting portion na of the optical deflection element, and also it does not display the image of the light emission type display unit 7, but displays only the image of the reflection type display unit 1 for the observer B who observes the display device 100 from the outside of the angle area θ. As described above, the viewing angle of the light emission type display unit for displaying the image through the optical deflection element 9 is narrower than the viewing angle of the reflection type display unit 1.

The display device 100 has two display modes. The display mode contains a one-screen display mode in which a single image is displayed irrespective of the viewing position, and a two-screen display mode in which two different images are displayed in accordance with the viewing position. The display image controller 17 can switch the display mode to any one of the two display modes by changing the ratio in brightness between the reflection type display unit 1 and the light emission type display unit 7.

In the one-screen display mode, the display image controller 17 controls the light source of the light emission type display unit 7 through the brightness controller 15, and changes the ratio in brightness between the reflection type display unit 1 and the light emission type display unit 7 so that the brightness of the light emission type display unit 7 is lower than that of the reflection type display unit 1. Accordingly, the image displayed by the light emission type display unit 7 is darker than the image displayed by the reflection type display unit 1. At this time, the image displayed on the light emission type display unit 7 and the image displayed on the reflection type display unit 1 may be different images or the same image.

Accordingly, in the case of the one-screen display mode, with respect to the light viewed by the observer A, the observer A more strongly observes the light reflected by the light reflection type display unit 1 than the light which is emitted from the light emission type display unit 7 and transmitted through the optical deflection element 9 and the reflection type display unit 1. Therefore, the observer A views the image displayed by the reflection type display unit 1 more preferentially than the image displayed by the light emission display unit 7. That is, not only the observer B, but also the observer A can view the image displayed by the reflection type display unit 1.

On the other hand, in the case of the two-screen display mode, the display image controller 17 displays different images on the light emission type display unit 7 and the reflection type display unit 1 through the cholesteric liquid crystal controller 11 and the LCD controller 13. At this time, the display image controller 17 controls the light source 5 of the light emission type display unit 7 through the brightness controller 15, and changes the ratio in brightness between the reflection type display unit 1 and the light emission type display unit 7 so that the brightness of the light emission type display unit 7 is higher than that of the reflection type display unit 1.

The brightness of the light emission type display unit 7 is determined in advance in association with the peripheral illuminance (illumination intensity) by calculations. AT this time, the relationship between the peripheral illuminance E and the brightness B is represented as follows.

B=KE/π
B: brightness (cd/m²)
K: reflection coefficient of object, the value is lower as the black is higher (in the case of perfect diffuse surface, K=1)
E: peripheral illuminance (lx: lux)
π: circle ratio (3.14159)
   According to the illumination standard of Japanese Industrial Standards Committee JIS Z 9110-1979, the illuminance (illumination intensity) under general environment ranges 750 lx to 1500 lx in working offices, 300 lx to 500 lx in general offices, 200 lx to 500 lx in rooms, and 75 lx to 150 lx in rest rooms. Accordingly, assuming that the reflection coefficient of cholesteric liquid crystal in a general office is equal to about 50%, the brightness Bc of the reflection type display unit 1 is represented as follows.

Bc=0.5×300/3.14=47 (cd/m²).

On the other hand, the maximum brightness of the light emission type display unit 7 is substantially identical to the brightness of the light source 5. For example, when the transmittance of the transmission type liquid crystal display panel 3 is equal to about 80%, the brightness of a backlight unit which is generally used as the light source 5 is equal to about 2000 cd/m², and thus the brightness of the light emission type display unit 7 is equal to about 1600 cd/m². That is, it is found that the brightness of the light emission type display unit 7 is larger than the brightness of the reflection type display unit 1 by about two digits, and the light emission type display unit 7 and the reflection type display unit is greatly different from each other in brightness.

With respect to the visibility of humans, humans observe light stimulus according to the log characteristic (Weber-Fechner Law). Therefore, the observer A observes the light from the light emission type display unit 7 more strongly than the brightness ratio between the light emission type display unit 7 and the reflection type display unit 1.

Furthermore, humans have an adaptive response, and thus the visual sense of humans reacts only to the image displayed by the light emission type display unit 7. Accordingly, it is rare that the image displayed on the light emission type display unit 7 with the brightness of the generally used backlight unit is hardly viewable due to the image displayed on the reflection type display unit 1, and thus the mask effect of the reflection type display unit 1 is little.

Accordingly, in the case of the two-screen display mode, with respect to the light viewed by the observer A, the observer Amore strongly observes the light which is emitted by the light emission type display unit 7 and transmitted through the optical deflection element 9 and the reflection type display unit 1 as compared with the light reflected from the reflection type display unit 1. Therefore, the observer A views the image displayed by the light emission type display unit 7 preferentially to the image displayed by the reflection type display unit 1. That is, when the observer B views the image displayed by the reflection type display unit 1, the observer A views the image displayed by the light emission type display unit 7.

FIG. 4A is a schematic diagram showing the state that an observer views the display device of the related art, and FIG. 4B is a schematic diagram showing the state that an observer views the display device according to this embodiment. In all the figures, the observers A and B are located at the same positions as the observers A, B in FIG. 3.

In the display device 800 of the related art, as shown in FIG. 4A, an image A1 containing personal information, for example, having a mail and an address is viewable from the observer A, however, an inky black (hatched) image B1 is viewed from the observer B.

On the other hand, in the display device 100 according to this embodiment, as shown in FIG. 4B, an image A2 containing personal information is viewable from the observer A, and an image B2 containing a public-openable display, for example, having a design such as a figure or the like and a time table is viewable from the observer B.

As described above, according to the first embodiment, the display device 100 has the reflection type display unit 1, the light emission type display unit 7 for displaying an image transmitted through the reflection type display unit 1 on the front surface side OS, and the optical deflection element 9 for making the viewing angle of the light emission display unit 7 smaller than the viewing angle of the reflection type display unit 1. Accordingly, at the front surface side OS of the reflection type display unit 1, the image displayed by the light emission type display unit 7 is viewed within the viewing angle of the light emission type display unit 7, and only the image displayed by the reflection type display unit 1 is viewed at the outside of the viewing angle of the light emission type display unit 7. As described above, the display device 100 can display an image different in accordance with the viewing angle without using any complicated mechanism. Accordingly, an image to which necessity of information protection is high such as personal information or the like is displayed for the user of the display device 100, and an image to which necessity of information protection is not needed is displayed for persons surrounding the user.

Furthermore, the display device 100 can change the ratio in brightness between the reflection type display unit 1 and the light emission type display unit 7. Accordingly, the one-screen display mode in which a single image is displayed irrespective of the viewing position and the two-screen display mode in which one of two different images is selectively displayed in accordance with the viewing position can be switched to each other.

### Second Embodiment

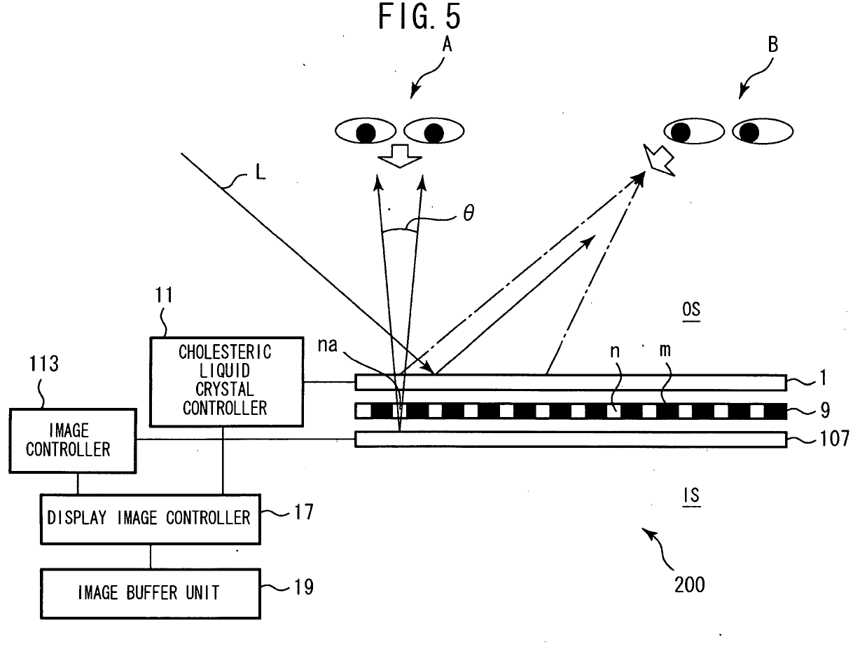

A display device according to a second embodiment will be described with reference to FIG. 5. FIG. 5 is a cross-sectional view showing a main part of the display device 200 according to this embodiment.

The display device 200 according to this embodiment has substantially the same construction as the display device 100 according to the first embodiment. The portions between the first and second embodiments are represented by the same reference numerals as the first embodiment, and the description thereof is omitted.

The display device 200 of this embodiment has a light emission type display unit 107 having a self-luminous property such as EL (ElectroLuminescence) or the like in place of the light emission type display unit 7 of the display device 100 according to the first embodiment. In connection with this change, the display device 200 has a pixel controller 113 for controlling the light emission type display unit 107 in place of the LCD controller 13 and the brightness controller 15.

The reflection type display unit 1, the optical deflection element 9 and the light emission type display unit 107 are successively stacked and arranged in this order from the front surface OS.

The same effect as the display device 100 according to the first embodiment can be also obtained by the display device 200 according to the second embodiment.

In the display device 200, the light emission type display unit 107 has a self-luminous property, and has a one-layer structure, and thus the overall thickness of the display device can be made smaller than the display device using the light emission type display unit having the two-layered structure having the transmission type liquid crystal display panel and the light source.

### Third Embodiment

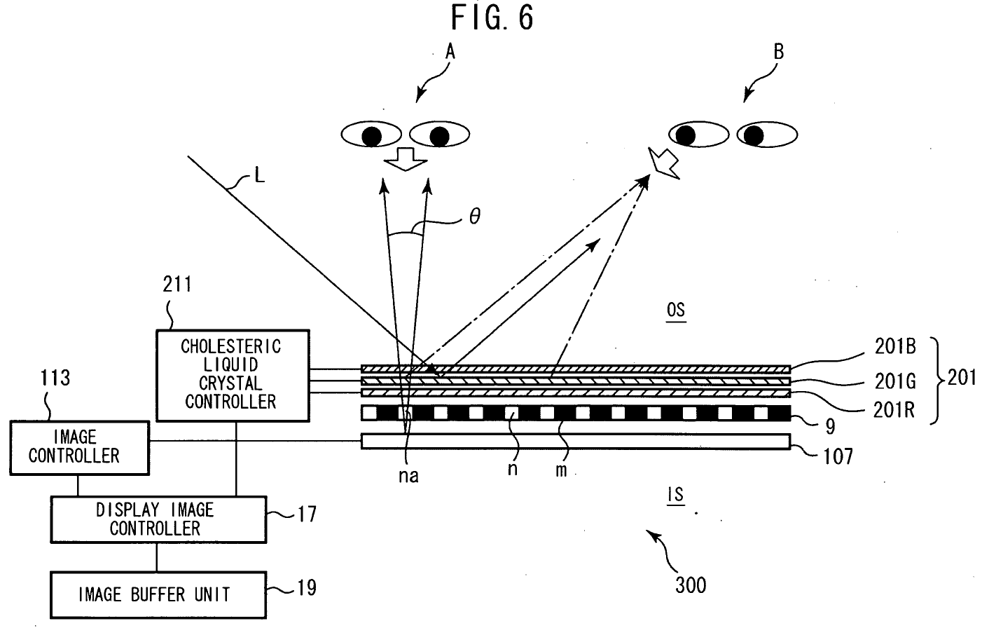

A display device according to a third embodiment will be described with reference to FIG. 6. FIG. 6 is a cross-sectional view showing a main part of the display device 300 according to this embodiment.

The display device 300 according to this embodiment has substantially the same construction as the display device 200 according to the second embodiment. The common portions are represented by the same reference numerals and the description thereof is omitted.

The display device 200 according to the second embodiment has the reflection type display unit 1 having the one-layer structure for reflecting only light of a single wavelength. However, the display device 300 according to this embodiment has a reflection type display unit 201 having a three-layer structure in which the respective spiral pitches of liquid crystal molecules of cholesteric liquid crystal in the respective layers are adjusted so that light having different wavelengths is reflected. The reflection type display unit 201 has an R reflection type display panel 201R for reflecting red light, a G reflection type display panel 201G for reflecting green light and a B reflection type display panel 201B for reflecting blue light, and these display panels are successively stacked in this order from the back side IS of the reflection type display unit 201 to the front side OS.

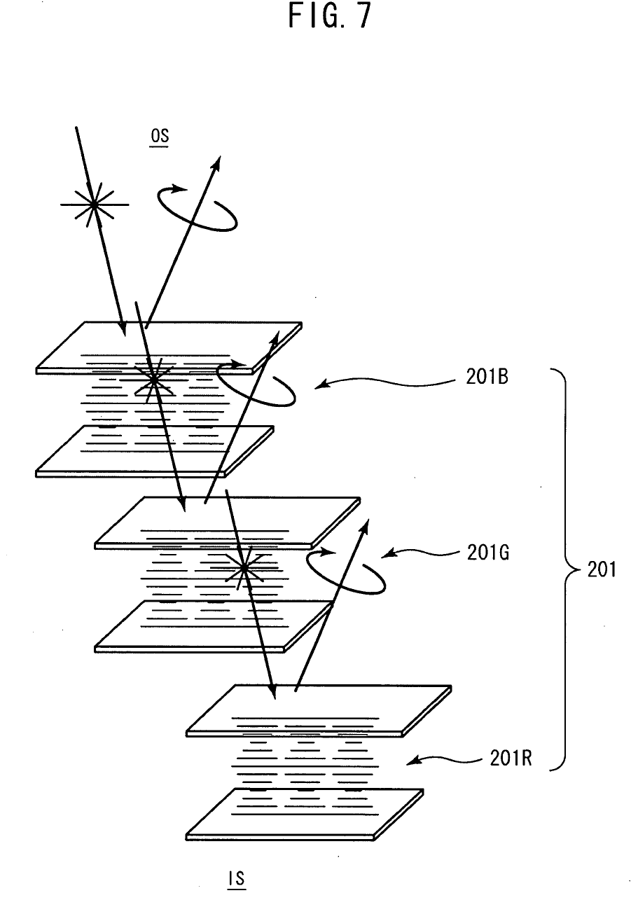

FIG. 7 is a schematic diagram showing an aspect that each of the reflection type display panels 201R, 201G, 201B reflects light.

Light reflected by cholesteric liquid crystal becomes circularly polarized light. Each of the reflection type display panels 201R, 201G, 201B reflects one light of counterclockwise circularly polarized light and clockwise circularly polarized light and transmits the other light therethrough although the light can be reflected and has the same wavelength.

In this embodiment, the circular polarization characteristics of the reflection type display panels 201R, 201G, 201B which are stacked in the three-layered structure are formed substantially in the same direction. The circularly polarized light reflected from each of the respective reflection type display panels 201R, 201G, 201B is conformed with one of counterclockwise circularly polarized light and clockwise circularly polarized light as shown in FIG. 7, whereby the transmission efficiency when light is transmitted through the reflection type display unit 201 can be enhanced from 10% to 20% as compare with a case where counterclockwise circularly polarized light and clockwise circularly polarized light are mixed with each other, thereby reducing the reduction amount of the brightness of light which is emitted from the light emission type display unit 107 and then transmitted through the reflection type display unit 201.

The display device 300 according to the third embodiment also has the same effect as the display device 100 according to the first embodiment.

The display device 300 according to the third embodiment has the reflection type display unit 201 having the three-layer structure which reflects light of three colors of red, green and blue, and thus it can perform color display.

In this embodiment, the light emission type display unit 7 using the light source 5 may be used in place of the light emission type display unit 107 having the self-luminous property.

### Fourth Embodiment

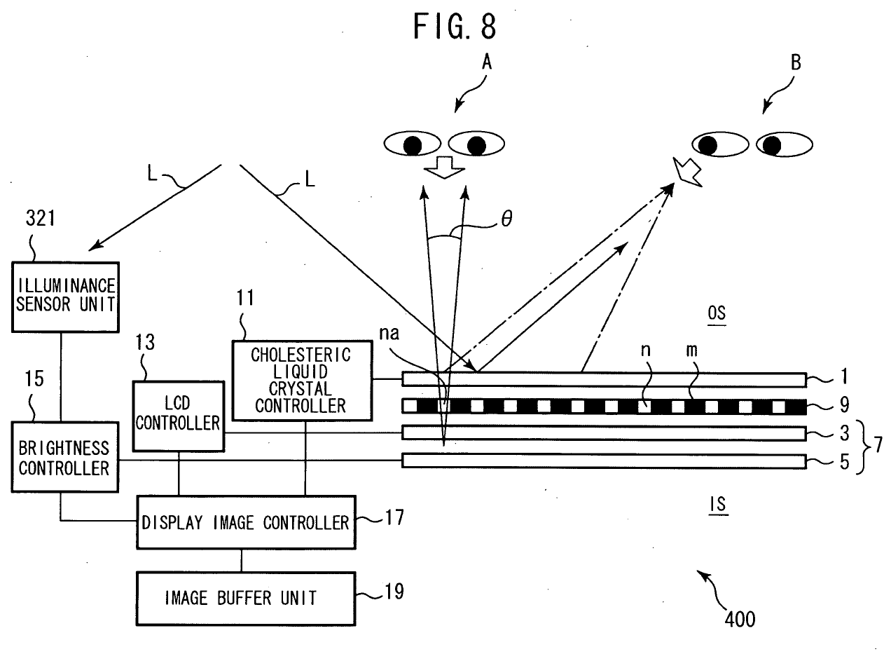

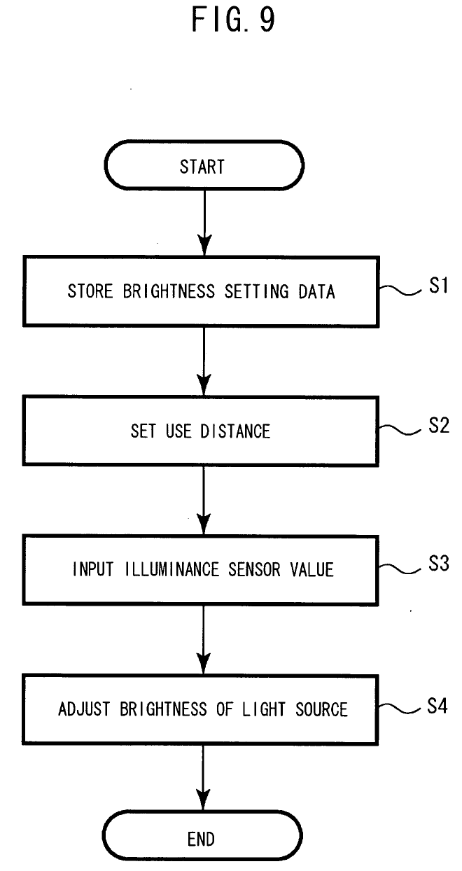

The display device according to the fourth embodiment will be described with reference to FIGS. 8 and 9. FIG. 8 is a cross-sectional view showing a main part of a display device 400 according to this embodiment.

The display device 400 according to this embodiment has substantially the same construction as the display device 100 according to the first embodiment. The common portions are represented by the same reference numerals, and the description thereof is omitted.

The display device 400 according to this embodiment has an illuminance sensor unit 321. The illuminance sensor unit 321 is disposed in the neighborhood of the reflection type display unit 1 to detect the illuminance of the front side OS. In connection with the provision of the illuminance sensor unit 321, the brightness controller 15 of this embodiment changes the light emission brightness of the light emission type display unit 7 in accordance with the illuminance value obtained from the illuminance sensor unit 321.

FIG. 9 is a flowchart showing a method of adjusting the brightness of the light source on the basis of the illuminance detected by the illuminance sensor unit 321.

First, the brightness controller 15 presets and stores brightness setting data on the basis of the detected illuminance and the display mode (step S1). Here, as the display mode is selected one of the one-screen display mode in which a single image is displayed irrespective of the viewing position and the two-screen display mode in which two different images are displayed in accordance with the viewing position. The brightness setting data are set so that the light source 5 of the light emission type display unit 7 is made to emit light at normal light emission brightness (for example, 2000 cd/m²) when an image is displayed in the two-screen display mode under the illuminance of a general office. On the other hand, when an image is displayed in the one-screen display mode, the brightness setting data are set so that the light source 5 of the light emission type display unit 7 is made to emit light at light emission brightness of about one digit (cd/m²). Furthermore, when an image is displayed in the two-screen display mode under the illuminance of twilight gloom, the brightness controller 15 sets the brightness to be lower than the normal light emission brightness, thereby keeping the brightness difference between the light emission type display unit 7 and the reflection type display unit 1 substantially constant. Accordingly, glittering of the light emission type display unit 7 is suppressed, and the display quality of the reflection type display unit 1 can be kept.

When the brightness setting data are stored, the brightness controller 15 sets as a use distance the distance between the observer A and the display device 100 when the display device 100 is used (step S2).

When the use distance is set, the brightness controller 15 obtains the illuminance value detected by the illuminance sensor unit 321 (step S3).

When the illuminance value is input from the illuminance sensor unit 321, the brightness controller 15 controls power supplied to the light source 5 to adjust the brightness of the light source 5 (step S4).

The display device 400 according to the fourth embodiment has the same effect as the display device 100 according to the first embodiment.

Furthermore, the display device 400 according to the fourth embodiment has the illuminance sensor portion 321, and thus can control the light emission type display unit 7 in accordance with the illuminance of the atmosphere under which the display device 400 is used.

### Fifth Embodiment

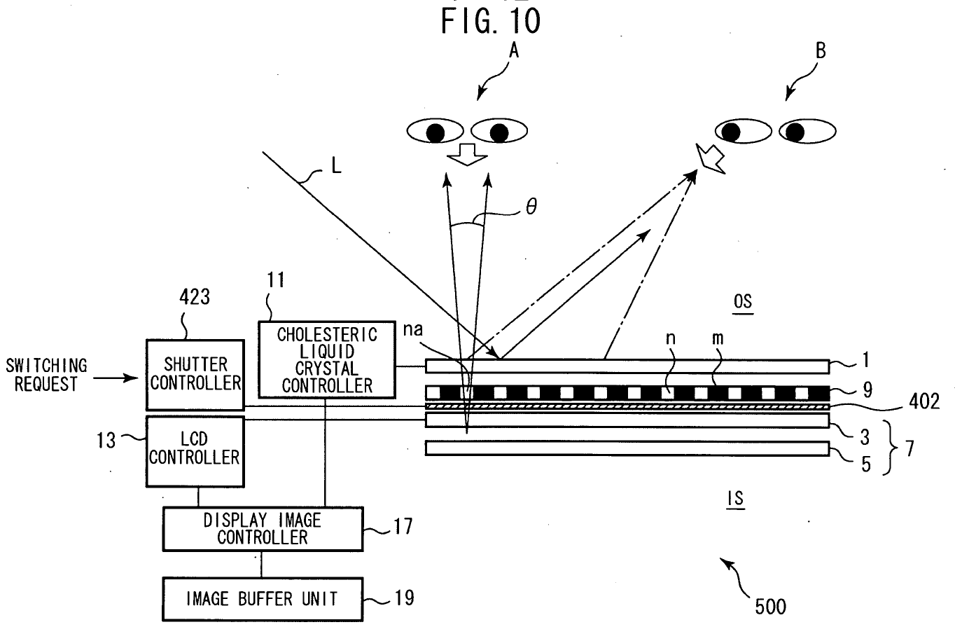

A display device according to a fifth embodiment will be described with reference to FIG. 10. FIG. 10 is a cross-sectional view showing a main part of the display device 500 according to this embodiment.

The display device 500 according to this embodiment has substantially the same construction as the display device 100 of the first embodiment. The common portions are represented by the same reference numerals, and the description thereof is omitted. The display device 500 has a shutter 402 and a shutter controller 423 in place of the brightness controller 15.

The shutter 402 is stacked and arranged between the light emission type display unit 7 and the optical deflecting element 9. The shutter 402 is provided to be openable and closable, and it allows light emitted from the light emission type display unit 7 to transmit therethrough and makes the transmitted light incident to the optical deflection element 9 when it is opened. On the other hand, when the shutter is closed, the shutter 402 intercepts light emitted from the light emission type display unit 7 to prevent the light from being incident to the optical deflection element 9. That is, the display device 500 switches the display mode by opening/closing the shutter 402.

The display device 500 according to the fifth embodiment has the same effect as the display device 100 according to the first embodiment.

Furthermore, the display device 500 according to the fifth embodiment is equipped with the shutter 402 and the shutter controller 423, whereby the display mode can be switched without controlling the brightness of the light source 5.

### Sixth Embodiment

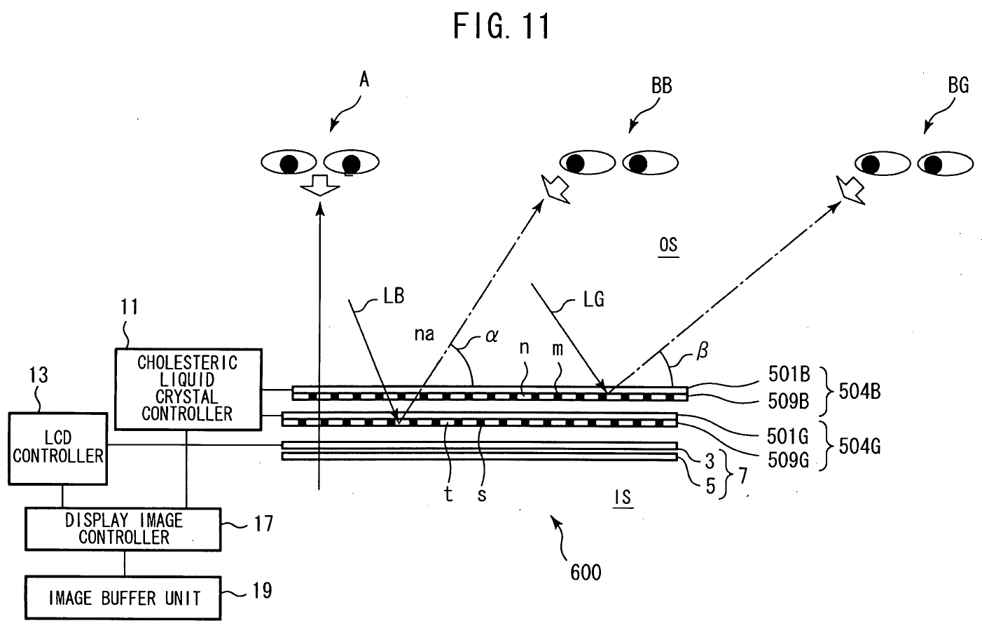

A display device according to a sixth embodiment will be described with reference to FIG. 11. FIG. 11 is a cross-sectional view showing a main part of the display 600 according to this embodiment.

The display device 600 according to this embodiment has substantially the same construction as the display device 100 according to the first embodiment. The common portions are represented by the same reference numerals, and the description thereof is omitted. The display device 100 according to the first embodiment has the reflection type display unit having the one-layer structure for reflecting only light of a single wavelength and one optical deflection element 9. However, the display device 600 of this embodiment has two reflection type display units 504B and 504G.

The reflection display unit 504B has a reflection type display unit 501B and an optical deflection element 509B stacked on the back side IS of the reflection type display unit 501B. In the reflection type display unit 504B, the spiral pitch of cholesteric liquid crystal is adjusted so as to reflect light of the wavelength corresponding to blue color light, for example.

The reflection type display unit 504G has a reflection type display unit 501G, and an optical deflection element 509G attacked on the back side IS of the reflection type display unit 501G. In the reflection type display unit 504G, the spiral pitch of cholesteric liquid crystal is adjusted so as to reflect light of the wavelength corresponding to green color light, for example.

The optical deflection elements 509B, 509G have the same construction and function as the optical deflection element 9 in the first embodiment.

The reflection type display unit 504G is disposed at the back side IS of the reflection type display unit 504B. At this time, the reflection type display unit 504G and the reflection type display unit 504B are stacked so as to be displaced from each other in the arrangement direction of the light shielding portions m by only the inverse number of the number of the stacked reflection type display units 504G, 504B (in this case, by the half of the arrangement pitch of the light shielding portions m) with respect to the opening width of the transmitting portions n of the optical deflection elements 509B, 509G.

Accordingly, an observer A who observes in the substantially vertical direction to the surface plane of the reflection type display unit 504B can view an image displayed on the light emission type display unit 7 through the gap between the light shielding portions m of the optical deflecting element 509B and the gap between the light shielding portions m of the optical deflecting element 509G.

An observer BB who observes in a direction of an angle α to the surface plane of the reflection type display unit 504B can view an image of green color displayed on the reflection type display unit 501G through the gap between light shielding portions m of the optical deflection element 509B. Here, the image displayed on the light emission display unit 7 cannot be viewed from the observer BB by the optical deflection element 509B and the optical deflection element 509G. Accordingly, the superposed image of the green image displayed on the reflection type display unit 501G and the blue image displayed on the reflection type display unit 501B is viewed from the observer BB.

An observer BG observes in a direction of an angle β which is smaller than the angle α with respect to the display plane of the reflection type display unit 504B. Light of the reflection type display unit 504G is shielded from the observer BG by the optical deflection element 509B, and thus only the blue image displayed on the reflection type display unit 501B is viewed.

The display device 500 according to the sixth embodiment has the same effect as the display device 100 according to the first embodiment.

Furthermore, the display device 600 according to the sixth embodiment can view three kinds of displays in accordance with the viewing position.

### Seventh Embodiment

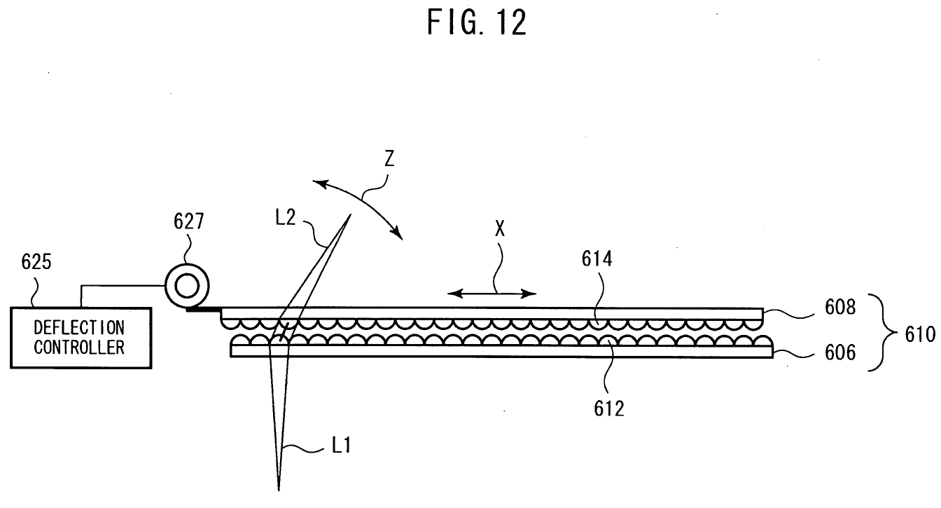

A display device according to a seventh embodiment will be described with reference to FIG. 12. FIG. 12 is a cross-sectional view showing a lenticular lens unit used in the display device of this embodiment.

The display device of this embodiment has substantially the same construction as the display device 100 of the first embodiment. A lenticular lens unit 610, a moving unit 627 and a deflection controller 625 are provided in place of the optical deflection element 9 (see FIG. 3). The common portions are represented by the same reference numerals, and the description thereof is omitted.

The lenticular lens unit 610 is provided with a pair of lenticular lenses 606, 608 which are stacked and arranged between the reflection type display unit 1 and the light emission type display unit 7 (see FIG. 3) so as to confront each other. The lenticular lens 606 disposed at the light emission type display unit 7 side is fixed to the display device, however, the lenticular lens 608 disposed at the reflection type display unit 1 side is movable in the direction of an arrow X along the lenticular lens 606.

A plurality of rod-shaped lens portions 612 each of which has a semicircular section are provided on the upper surface of the lenticular lens 606 disposed at the light emission type display unit 7 side so as to be arranged in the direction of the arrow X.

A plurality of rod-shaped lens portions 614 each of which has a semicircular section are provided on the lower surface of the lenticular lens 608 disposed at the reflection type display unit 1 side so as to be arranged in the direction of the arrow X. Here, the lens portions 612 and 614 are formed to have substantially the same dimension. The rod-like extension direction of the lens portions 612 of the lenticular lens 606 and the rod-like extension direction of the lens portions 614 of the lenticular lens 608 are set to be substantially parallel to each other.

The moving unit 627 is connected to the lenticular lens 608 disposed at the reflection type display unit 1 side. This moving unit 627 slides the lenticular lens 608 in the arrangement direction of the arrow X of the plural lends portions 612 by driving force.

The deflection controller 625 is a control unit for the moving unit 627. The deflection controller 625 moves the lenticular lens 608 through the moving unit 627 to control the deflection direction of the lenticular lens unit 610. The deflection controller 625 is operated under the control of the display image controller 17 (see FIG. 3), for example.

The lenticular lens unit 610 can change the deflection direction like light L2 when light L1 incident from the light emission type display unit 7 is deflected. At this time, by moving the lenticular lens 608 in the direction of the arrow X, the deflection direction of the light L2 can be changed as indicated by an arrow Z. That is, the pair of lenticular lenses 606 and 608 can change the viewing direction of the light emission type display unit 7 in accordance with the relative position thereof.

The same effect as the first embodiment can be also achieved by the display device of the seventh embodiment.

Furthermore, by providing the movable type lenticular lens unit 610, the deflection direction of the image displayed by the light emission type display unit 7 can be changed.

In the above embodiments, the interval between the light shielding portions m or transmitting portions n of the optical deflection element is set to be substantially equal to the interval between the pixels of the light emission type display unit, however, the display device is not limited to this style. For example, the interval between the light shielding portions or light transmitting portions of the optical deflection element may be set to be substantially equal to an integral multiple of the interval between the pixels of the light emission type display unit.

In the above embodiments, the portable equipment in which the display device is mounted is used. However, for example, the display device may be applied to an outdoor advertisement or the like. At this time, the brightness of the light emission type display unit and the brightness of the reflection type display unit may be fixed all day, whereby an observer can view an image displayed on the reflection type display unit under a bright environment during daylight and also view an image displayed on the light emission type display unit under a dark environment at nighttime.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display device comprising:
a reflection type display unit reflecting light of a predetermined wavelength at a front surface side to display a first image at the front surface side;
a light emission type display unit disposed at a back side of the reflection type display unit and displaying a second image different from the first image at the front surface side through the reflection type display unit; and
an optical deflection element which restricts a viewing angle of the light emission type display unit so that the viewing angle of the light emission type display unit is smaller than a viewing angle of the reflection type display unit.

2. The display device according to claim 1, wherein the optical deflection element is disposed between the reflection type display unit and the light emission type display unit.

3. The display device according to claim 1, wherein the image displayed by the light emission type display unit is brighter than the image displayed by the reflection type display unit.

4. The display device according to claim 1, further comprising a brightness controller controlling a ratio between a reflection illuminance of the reflection type display unit and a light emission brightness of the light emission type display unit.

5. The display device according to claim 1, wherein the light emission type display unit has a light source, and a transmission type liquid crystal display panel transmitting therethrough a light emitted from the light source to display an image.

6. The display device according to claim 1, wherein the light emission type display unit has a self-luminous property.

7. The display device according to claim 1, further comprising an illuminance sensor for detecting an illuminance of the front surface side, wherein the light emission brightness of the light emission type display unit is changed in accordance with a detection result of the illuminance sensor.

8. The display device according to claim 1, wherein the reflection type display unit has a liquid crystal forming a cholesteric phase.

9. The display device according to claim 1, wherein the optical deflection element has a plurality of light shielding portions linearly formed of a material having a light shielding property and the light shielding portions are arranged at an equal interval in a strip pattern.

10. The display device according to claim 1, wherein the optical deflection element includes a pair of lenticular lenses, and a viewing direction of the light emission type display unit is changed according to a relative position between the pair of the lenticular lenses.

11. The display device according to claim 1, wherein the reflection type display unit has at least two stacked reflection type display panels reflecting lights having different wavelengths respectively.

12. The display device according to claim 11, wherein the reflection type display unit is configured so that the circularly polarized light characteristics of the reflection type display panels are formed in the same direction.

13. The display device according to claim 11, wherein the optical deflection element is provided at the back side of each of the reflection type display panels of the reflection type display unit, and the reflection type display panels are arranged so as to be displaced along the surface planes thereof.

14. The display device according to claim 1, further comprising a shutter disposed between the reflection type display unit and the light emission type display unit so that a light emitted from the light emission type display unit is prevented from reaching the reflection type display unit.

15. The display device according to claim 10, wherein the pair of lenticular lenses are arranged so as to confront each other, and one of the lenticular lenses is movable in relation to the other lenticular lens so that the viewing direction varies.
